(19) United States
(12) Patent Application Publication
(10) Pub. No.: US 2004/0200436 A1
(43) Pub. Date: Oct. 14, 2004

(54) Spring tether

(76) Inventor: Lavra A.Saylor Staack, Walkerton, IN (US)

Correspondence Address: Laura A. Saylor, 9562E 750N, Walkerton, IN, 46574, US

(21) Appl. No.: 10/785,137

(22) Filed: Feb. 24, 2004

Related U.S. Application Data
(60) Provisional application No. 60/449,747, filed on Feb. 24, 2003.

(51) Int. Cl. A01K 27/00

(52) U.S. Cl. 119/792

(57) ABSTRACT

This invention, The Spring Tether, is designed to reduce risk of entanglement and increase safety of a tied or tethered animal, such as an equine, bovine, or such. It also allows the animal more head freedom while increasing the safety. An animal will have the ability to eat or drink from pans or feeders on the ground, to lay down and stand while tied or tethered and The Spring Tether's coils kepts tension which removes excess slack and the risk of entanglement.

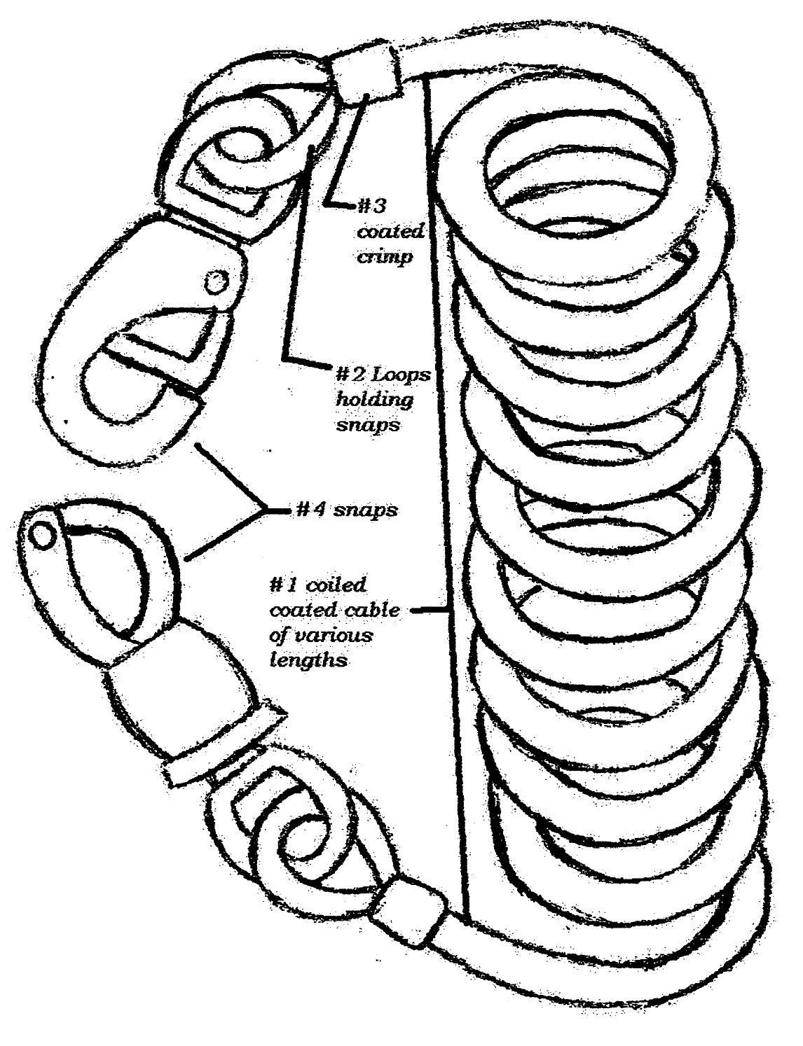

This invention, The Spring Tether, is designed to reduce risk of entanglement and increase safety of a tied or tethered animal, such as an equine, bovine, or such. It also allows the animal more head freedom while increasing the safety. An animal will have the ability to eat or drink from pans or feeders on the ground, to lay down and stand while tied or tethered and The Spring Tether's coils kepts tension which removes excess slack and the risk of entanglement.

The Spring Tether, as shown in the drawing on page 3, is designed of a coiled coated cable that comes in verious lengths. (1) It has loops at each end (2) which are held by crimps (3) that are also coated for protection. In each loop is a snap (4) at is used to connect to a halter or collar and a fast or permentant hitching object (such as, but not limited to, Hitch rails, Trailers, Barn ties and such . . . )

1. A Spring Tether comprising:
(a) a coiled coated cable that comes in verious lengths
(b) it has loops at each end
(c) which are held by crimps
(d) in each said loop is a snap
